(19) United States
(12) Patent Application Publication
(10) Pub. No.: US 2019/0025626 A1
(43) Pub. Date: Jan. 24, 2019

(54) CURVED-SURFACE LIQUID CRYSTAL DISPLAY PANEL AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Dongchuan CHEN, Beijing (CN); Hongming ZHAN, Beijing (CN); Zhe LI, Beijing (CN); Xibin SHAO, Beijing (CN)

(21) Appl. No.: 15/925,537

(22) Filed: Mar. 19, 2018

(30) Foreign Application Priority Data
Jul. 18, 2017 (CN) 201710587568.1

(51) Int. Cl. G02F 1/13363; G02F 1/1335; G02F 1/1333; G02F 1/1337

(52) U.S. Cl. CPC G02F 1/13363; G02F 1/133528; G02F 2001/133761; G02F 1/133753; G02F 1/133305

(57) ABSTRACT

A curved-surface liquid crystal display panel and a display device are disclosed. The curved-surface liquid crystal display panel includes an array substrate and an opposite substrate, a liquid crystal layer including first liquid crystal molecules, a lower polarizer, an upper polarizer, a lower compensation layer, and an upper compensation layer. Each of the upper compensation layer and the lower compensation layer includes second liquid crystal molecules having a birefringence different from that of the first liquid crystal molecules. A direction of pre-tilt angles of the second liquid crystal molecules in the upper compensation layer and a direction of a light absorption axis of the upper polarizer forms a non-zero first angle, and the direction of pre-tilt angles of the second liquid crystal molecules in the lower compensation layer and a direction of a light absorption axis of the lower polarizer forms a non-zero second angle.

### CROSS REFERENCE TO RELATED APPLICATION

This application claims priority to the patent application No. 201710587568.1 filed with the Patent Office of the People's Republic of China on Jul. 18, 2017, the disclosure of which is incorporated herein by reference.

### TECHNICAL FIELD

The present disclosure relates to a curved-surface liquid crystal display panel and a display device.

### BACKGROUND

With the continuous development of liquid crystal televisions, curved-surface liquid crystal televisions emerge to adapt to human eyes, so as to further improve users' experiences of viewing the images. The curved-surface liquid crystal televisions realize curved-surface display mainly by means of the elasticity of the liquid crystal display panel itself. However, when the liquid crystal display panel is bent, the optical characteristic thereof tends to change, resulting in different phase differences at different positions of the liquid crystal display panel.

### SUMMARY

An embodiment of the present disclosure provides a curved-surface liquid crystal display panel comprising: an array substrate and an opposite substrate facing each other; a liquid crystal layer between the array substrate and the opposite substrate, the liquid crystal layer comprising first liquid crystal molecules; a lower polarizer arranged on a side of the array substrate away from the opposite substrate; an upper polarizer arranged on a side of the opposite substrate away from the array substrate; a lower compensation layer between the lower polarizer and the array substrate; and an upper compensation layer between the upper polarizer and the opposite substrate. Moreover, each of the upper compensation layer and the lower compensation layer comprises second liquid crystal molecules having a birefringence different from that of the first liquid crystal molecules, a direction of pre-tilt angles of the second liquid crystal molecules in the upper compensation layer and a direction of a light absorption axis of the upper polarizer forms a non-zero first included angle, a direction of pre-tilt angles of the second liquid crystal molecules in the lower compensation layer and a direction of a light absorption axis of the lower polarizer forms a non-zero second included angle.

In some embodiments, the first included angle between the direction of pre-tilt angles of the second liquid crystal molecules in the upper compensation layer and the direction of the light absorption axis of the upper polarizer is about 90 degree, the second included angle between the direction of pre-tilt angles of the second liquid crystal molecules in the lower compensation layer and the direction of the light absorption axis of the lower polarizer is about 90 degree.

In some embodiments, the direction of the light absorption axis of the upper polarizer is substantially perpendicular to the direction of the light absorption axis of the lower polarizer.

In some embodiments, the first liquid crystal molecules in the liquid crystal layer are rod-like liquid crystal molecules, which are substantially in spiral arrangement in a thickness direction of the liquid crystal layer, a direction of pre-tilt angles of an uppermost layer of rod-like liquid crystal molecules in the liquid crystal layer is substantially parallel to the direction of the light absorption axis of the upper polarizer, and a direction of pre-tilt angles of a lowermost layer of rod-like liquid crystal molecules in the liquid crystal layer is substantially parallel to the direction of the light absorption axis of the lower polarizer.

In some embodiments, the direction of the light absorption axis of the upper polarizer is substantially parallel to the direction of the light absorption axis of the lower polarizer.

In some embodiments, the first liquid crystal molecules in the liquid crystal layer are rod-like liquid crystal molecules, a direction of pre-tilt angles of the rod-like liquid crystal molecules is substantially parallel or perpendicular to the direction of the light absorption axis of the upper polarizer.

In some embodiments, a phase delay of light passing through each of the upper compensation layer and the lower compensation layer is between 15 nm and 65 nm.

In some embodiments, a birefringence of the second liquid crystal molecules is within a range of 0.001-0.008.

In some embodiments, a thickness of the second liquid crystal molecules is within a range of 0.586 μm-1.686 μm.

In some embodiments, each of the second liquid crystal molecules has a substantially disc shape.

Another embodiment of the present disclosure provides a display device, comprising the curved-surface liquid crystal display panel as described in any one of the above embodiments.

### BRIEF DESCRIPTION OF DRAWINGS

FIG. 1a is a schematic explosive view of a planar liquid crystal display panel according to an example of the disclosure;

FIG. 1b illustrates color cast for a curved-surface liquid crystal display panel according to an example of the disclosure;

FIG. 2a is a schematic view of a curved-surface liquid crystal display panel provided in an embodiment of the disclosure;

FIG. 2b is a schematic view of an upper (lower) compensation layer in the curved-surface liquid crystal display panel provided in the embodiment of the present disclosure;

FIGS. 3a and 3b are schematic explosive views of the curved-surface liquid crystal display panel provided in the embodiment of the present disclosure for realizing a display of normally white mode;

FIGS. 4a and 4b are schematic explosive views of the curved-surface liquid crystal display panel provided in the embodiment of the present disclosure for realizing a display of normally black mode;

FIGS. 5a and 5b illustrate the effect of color cast reduction achieved by the curved-surface liquid crystal display panel provided in the embodiment of the disclosure.

### DETAILED DESCRIPTION OF EMBODIMENTS

In the following, implementations of the curved-surface liquid crystal display panel and display device provided in embodiments of the disclosure will be described in detail below with reference to the drawings.

The thicknesses and shapes of the layers shown in the figures do not reflect the true proportion of components of the curved-surface liquid crystal display panel, but they are only provided to illustrate the disclosure.

Inventors of the application realize that, for a TN (twisted nematic) liquid crystal display panel, a compensation layer may be disposed between the polarizer and the liquid crystal display panel in order to increase the viewing angle. That is to say, the viewing angle of the liquid crystal display panel is adjusted by means of phase compensation, thereby achieving a wide viewing angle.

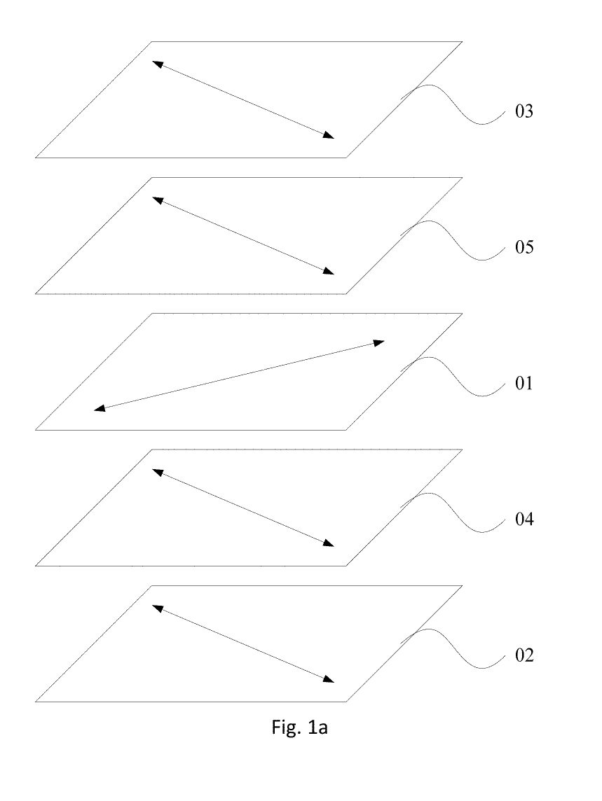

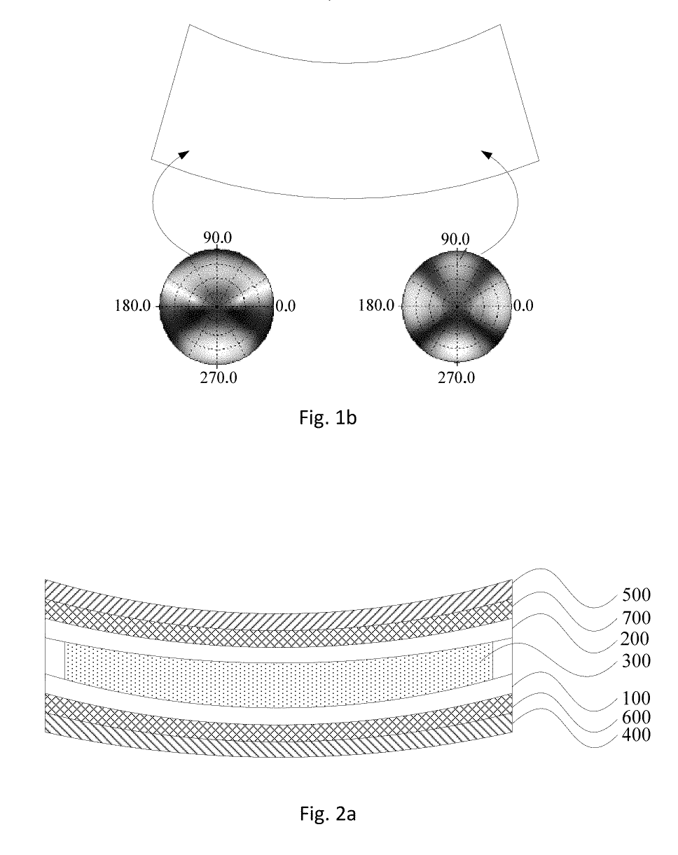

Therefore, in an embodiment of the disclosure, as shown in FIG. 1a, a lower compensation layer 04 comprising disc-shape liquid crystal molecules is arranged between a liquid crystal layer 01 and a lower polarizer 02, a direction of pre-tilt angles of the disc-shape liquid crystal molecules is parallel to a direction of a light absorption axis of the lower polarizer 02, meanwhile, an upper compensation layer 05 comprising disc-shape liquid crystal molecules is arranged between the liquid crystal layer 01 and an upper polarizer 03, the direction of pre-tilt angles of the disc-shape liquid crystal molecules being parallel to a direction of a light absorption axis of the upper polarizer 03. The lower compensation layer and the upper compensation layer can deflect polarized light passing therethrough by a certain angle so as to offset a phase difference caused by an inevitable slight upward tilt of the liquid crystal molecules in the liquid crystal layer 01 occurred in the manufacturing (friction) process. Those skilled in the art shall be able to understand that the “pre-tilt angle” mentioned herein refers to the included angle between the liquid crystal molecules and the plane of the display panel, and the pre-tilt angle can be formed by irradiating the liquid crystal molecules with UV light.

Nevertheless, the inventors find that, with respect to the liquid crystal display panel in a curved state, the phase difference caused by the curve would influence the phase compensation process by the compensation layers, which may cause color deviations among respective areas of the liquid crystal display panel, i.e. a problem of color cast will be incurred to the display.

For instance, in an example, as shown in FIG. 1b, when the liquid crystal display panel is curved, there is less blue light (B) but more green light (G) and red light (R) at the upper left corner and the lower right corner of the display area of the liquid crystal display panel, thus a pink color is exhibited (the lower right drawing in FIG. 1b shows a color contour for the lower right corner of the display panel), i.e. under a dark state, the upper left corner and lower right corner of the liquid crystal display panel are rich in red color. While at the upper right color and lower left corner of the liquid crystal display panel, there is more blue light (B) but less green light (G) and red light (R), so a blue color is exhibited (the lower left drawing in FIG. 1b shows a color contour for the lower left corner of the display panel), i.e. under a dark state, the lower left corner and upper right corner of the liquid crystal display panel are rich in blue color. That is, curving of the liquid crystal display panel tends to cause color deviations among different areas of the display panel.

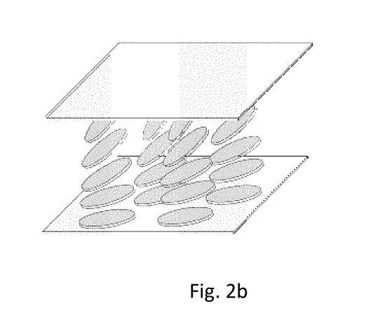

Hence, according to another embodiment of the disclosure, as shown in FIG. 2a, the curved-surface liquid crystal display panel comprises an array substrate 100 and an opposite substrate 200 facing each other, a liquid crystal layer 300 between the array substrate 100 and the opposite substrate 200, a lower polarizer 400 on a side of the array substrate 100 away from the opposite substrate 200, an upper polarizer 500 on a side of the opposite substrate 200 away from the array substrate 100, a lower compensation layer 600 between the lower polarizer 400 and the array substrate 100, and an upper compensation layer 700 between the upper polarizer 500 and the opposite substrate 200. Each of the upper compensation layer 700 and the lower compensation layer 600 has disc-shape liquid crystal molecules, as shown in FIG. 2b. Moreover, there is a non-zero first included angle between a direction of pre-tilt angles of the disc-shape liquid crystal molecules in the upper compensation layer 700 and a direction of a light absorption axis of the upper polarizer 500, and there is a non-zero second included angle between the direction of pre-tilt angles of the disc-shape liquid crystal molecules in the lower compensation layer 600 and a direction of a light absorption axis of the lower polarizer 400.

In a thickness direction of the upper compensation layer or lower compensation layer, the per-tilt angles of the disc-shape liquid crystal molecules can be variable, for example, gradually increasing or gradually decreasing from the bottom up. In a horizontal direction perpendicular to the thickness direction of the upper compensation layer or the lower compensation layer, the disc-shape liquid crystal molecules may have the same pre-tilt angles. In the present disclosure, liquid crystal molecules in the liquid crystal layer 300 for displaying in the curved-surface liquid crystal display panel are referred to as first liquid crystal molecules, and liquid crystal molecules in the upper compensation layer and the lower compensation layer are referred to as second liquid crystal molecules. In the embodiment shown in FIG. 2a and subsequent embodiments, the birefringence of the second liquid crystal molecules is different from that of the first liquid crystal molecules. It is mentioned herein that the upper compensation layer or lower compensation layer comprises disc-shape liquid crystal molecules, but the shape of the second liquid crystal molecules is not limited to the disc shape, the disc-shape second liquid crystal molecules are only taken as an example herein for illustration. The shape of the first liquid crystal molecules includes, but is not limited to, the rod shape.

As compared to the embodiment shown in FIG. 1a, in this embodiment, the direction of pre-tilt angles of the disc-shape liquid crystal molecules in the upper compensation layer 700 is not parallel to the light absorption axis direction of the upper polarizer 500, but there is a non-zero included angle therebetween. Likewise, there is also a non-zero included angle between the direction of pre-tilt angles of the disc-shape liquid crystal molecules in the lower compensation layer 600 and the light absorption axis direction of the lower polarizer 400. This can help to make the light transmissivities for sub-pixels (R/G/B) in respective areas of the display panel to become consistent, thereby alleviating the problem of color cast for the curved surface display. In addition, as mentioned before, in the thickness direction of the upper compensation layer or lower compensation layer, the pre-tilt angles of the disc-shape liquid crystal molecules can be variable. In this case, the upper compensation layer or the lower compensation layer can be considered as comprising liquid crystal molecule layers having different pre-tilt angles. Since the liquid crystal molecules of different layers have different pre-tilt angles, they have different transmissivities to light of different colors, thus the upper compensation layer or the lower compensation layer can regulate the light transmissivities for sub-pixels (R/G/B) in different areas of the curved-surface liquid crystal display panel, thereby further alleviating color cast during curved-surface display.

In the curved-surface liquid crystal display panel provided in an embodiment, the first included angle between the direction of pre-tilt angles of the disc-shape liquid crystal molecules in the upper compensation layer 700 and the light absorption axis direction of the upper polarizer 500 can be any value greater than 0 but not more than 90°. Similarly, the second included angle between the direction of pre-tilt angles of the disc-shape liquid crystal molecules in the lower compensation layer 600 and the light absorption axis direction of the lower polarizer 400 can be any value greater than 0 but not more than 90°. Moreover, according to simulated experiments, as the values of the first included angle and the second included angle become larger, the effect of color cast reduction on the curved-surface liquid crystal display panel becomes more obvious.

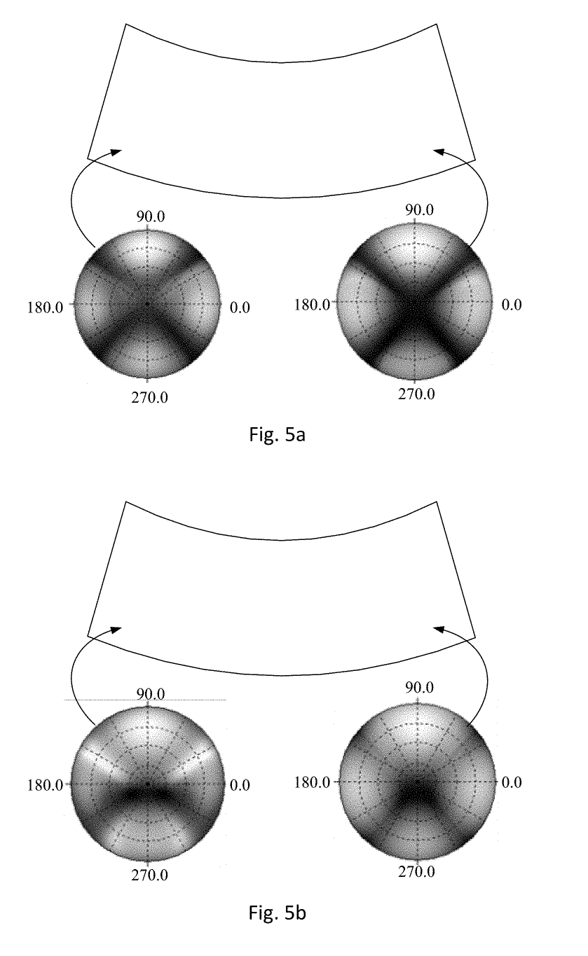

Therefore, in an embodiment, the first included angle between the direction of pre-tilt angles of the disc-shape liquid crystal molecules in the upper compensation layer 700 and the light absorption axis direction of the upper polarizer 500 is about 90 degrees, i.e. the direction of pre-tilt angles of the disc-shape liquid crystal molecules in the upper compensation layer 700 is substantially perpendicular to the light absorption axis direction of the upper polarizer 500; correspondingly, the second included angle between the direction of pre-tilt angles of the disc-shape liquid crystal molecules in the lower compensation layer 600 and the light absorption axis direction of the lower polarizer 400 is about 90 degrees, i.e. the direction of pre-tilt angles of the disc-shape liquid crystal molecules in the lower compensation layer 600 is substantially perpendicular to the light absorption axis direction of the lower polarizer 400. In this way, the problem of color cast for the curved-surface liquid crystal display panel can be alleviated maximally, as shown in FIG. 5a.

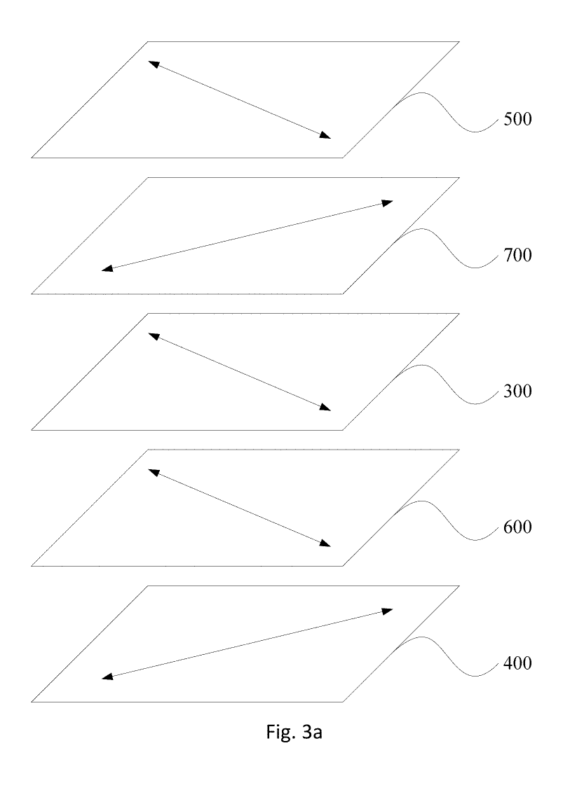

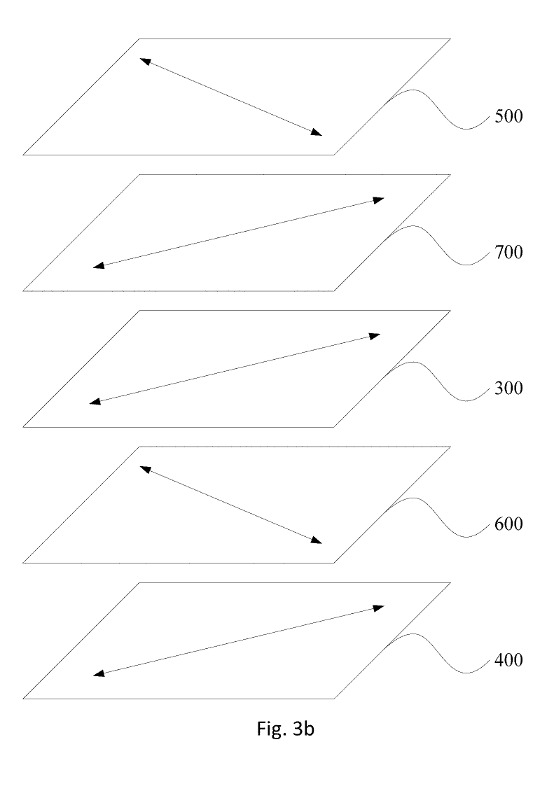

In the curved-surface liquid crystal display panel according to an embodiment of the disclosure, as shown in FIGS. 3a and 3b, the light absorption axis direction of the upper polarizer 500 is substantially perpendicular to the light absorption axis direction of the lower polarizer 400. In this case, when no electrical field is applied to the liquid crystal molecules layer 300, light passes through the lower polarizer 400 and becomes a polarized light having a first polarization direction. The polarized light of the first polarization direction is modulated by the disc-shape liquid crystal molecules in the lower compensation layer 600, then it passes through the liquid crystal layer 300 to have its polarization direction rotated by 90 degrees and becomes a second polarized light having a second polarization direction. The polarized light of the second polarization direction is modulated by the disc-shape liquid crystal molecules in the upper compensation layer 700 and exits through the upper polarizer 500. In this case, display of a normally white mode can be realized.

In specific implementation, in the curved-surface liquid crystal display panel provided in the embodiment of the disclosure, the liquid crystal layer 300 has rod-like liquid crystal molecules. In the normally white mode, the rod-like liquid crystal molecules are substantially in a spiral arrangement in a thickness direction of the liquid crystal layer 300. A direction of pre-tilt angle of an uppermost layer of rod-like liquid crystal molecules in the liquid crystal layer 300 is parallel to the direction of the light absorption axis of the upper polarizer 500, as shown in FIG. 3a, and a direction of pre-tilt angle of a lowermost layer of rod-like liquid crystal molecules in the liquid crystal layer 300 is parallel to the direction of the light absorption axis of the lower polarizer 400, as shown in FIG. 3b, thereby realizing display of normally white mode.

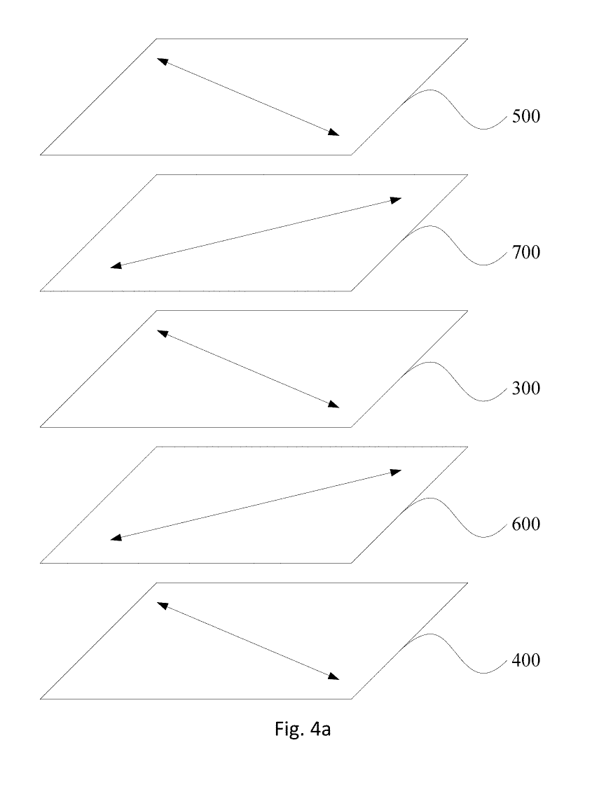

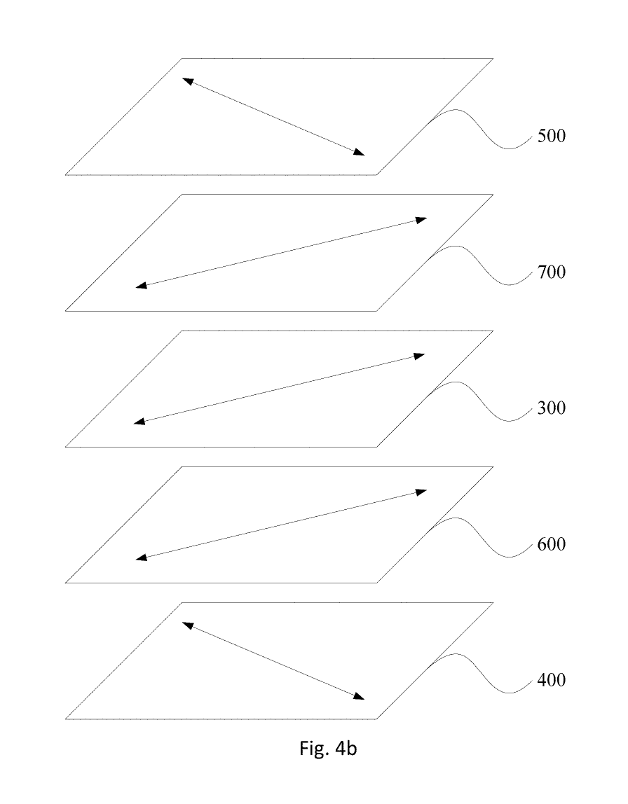

In a curved-surface liquid crystal display panel provided in another embodiment of the present disclosure, as shown in FIGS. 4a and 4b, the light absorption axis direction of the upper polarizer 500 is parallel to the light absorption axis direction of the lower polarizer 400. In this case, when no electrical field is applied to the liquid crystal layer 300, light passes through the lower polarizer 400 and becomes a polarized light having a first polarization direction. The polarized light of the first polarization direction is modulated by the disc-shape liquid crystal molecules in the lower compensation layer 600, then it passes through the liquid crystal layer 300 to have its polarization direction rotated by 90 degrees and becomes a second polarized light having a second polarization direction. The polarized light of the second polarization direction is modulated by the disc-shape liquid crystal molecules in the upper compensation layer 700 and then is completely absorbed by the upper polarizer 500. In this case, display of normally black mode can be realized.

In an example, for the curved-surface liquid crystal display panel, as shown in FIG. 4a, the direction of pre-tilt angles of the rod-like liquid crystal molecules in the liquid crystal layer 300 is parallel to the light absorption axis direction of the upper polarizer 500, namely, the direction of pre-tilt angles of the rod-like liquid crystal molecules in the liquid crystal layer 300 is also parallel to the light absorption axis direction of the lower polarizer 400, so as to realize display of normally black mode. Alternatively, as shown in FIG. 4b, the direction of pre-tilt angles of the rod-like liquid crystal molecules in the liquid crystal layer 300 is perpendicular to the light absorption axis direction of the upper polarizer 500, namely, the direction of pre-tilt angles of the rod-like liquid crystal molecules in the liquid crystal layer 300 is also perpendicular to the light absorption axis direction of the lower polarizer 400, so as to realize display of normally black mode.

In order to further alleviate the problem of color cast for the curved-surface liquid crystal display panel, in a curved-surface liquid crystal display panel provided in another embodiment of the present disclosure, compensation degrees to the lower compensation layer 600 and the upper compensation layer 700 can be controlled, so that colors presented at different viewing angles become consistent. In an example, a phase delay of light passing through each of the upper compensation layer 700 and the lower compensation layer 600 is between 15 nm and 65 nm, which may effectively improve the color cast occurred in the curved-surface display panel under dark state, and enables colors at different viewing angles to become consistent, as shown in FIG. 5b. In the example of the present disclosure, the phase delays generated by the disc-shape liquid crystal molecules in the upper compensation layer 700 and the lower compensation layer 600 can be the same or different, which is not limited herein.

In the curved-surface liquid crystal display panel provided in the embodiment of the disclosure, the phase delay generated by the disc-shape liquid crystal molecules in the upper compensation layer 700 and the lower compensation layer 600 mainly depends on Δn and d, Δn is the birefringence of the disc-shape liquid crystal molecules, and d represents the thickness of the disc-shape liquid crystal molecules. Therefore, the phase delay can be regulated by controlling the values of Δn and d.

In an example, the birefringence Δn of the disc-shape liquid crystal molecules is within the range of 0.001-0.008. Besides, the birefringence Δn of the disc-shape liquid crystal molecules in the upper compensation layer 700 can be the same as or different from the birefringence Δn of the disc-shape liquid crystal molecules in the lower compensation layer 600, which is not limited herein. The thickness d of the disc-shape liquid crystal molecules is within the range of 0.586 μm-1.686 μm. Besides, the thickness d of the disc-shape liquid crystal molecules in the upper compensation layer 700 can be the same as or different from the thickness d of the disc-shape liquid crystal molecules in the lower compensation layer 600, which is not limited herein.

Based on the same inventive concept, another embodiment of the present disclosure provides a display device, which comprises the curved-surface liquid crystal display panel as provided in any of the embodiments of the disclosure. The display device can be any product or component having a display function, such as a mobile phone, a tablet PC, a television, a monitor, a laptop PC, a digital photo frame, a navigator. As for the implementation of the display device, reference can be made to the implementation of the curved-surface liquid crystal display panel, while the repetitions will not be elaborated any more herein.

With the curved-surface liquid crystal display panel and display device provided in embodiments of the disclosure, there is a non-zero included angle between the direction of pre-tilt angles of the disc-shape liquid crystal molecules in the upper compensation layer and the light absorption axis direction of the upper polarizer, and there is a non-zero included angle between the direction of pre-tilt angles of the disc-shape liquid crystal molecules in the lower compensation layer and the light absorption axis direction of the lower polarizer, thus the light emission amounts of sub-pixels in different areas of the curved-surface liquid crystal display panel can be adjusted to make the light transmittance of sub-pixels in respective areas become consistent, as a result, the problem of color cast for the curved surface display can be alleviated.

Those skilled in the art can make various changes and modifications to embodiments the disclosure without departing from the spirit and scope of the invention. Therefore, the invention intends to include such changes and modifications if they fall into the scope of the appended claims and the equivalents thereof.

In the claims, the word “comprise” or “include” does not exclude existence of other components or steps, and the article “a” or “an” does not mean to exclude plurality. The fact that several technical means are stated in different dependent claims does not mean that combinations of these technical means cannot be used to advantage.

1. A curved-surface liquid crystal display panel, comprising:
an array substrate and an opposite substrate facing each other;
a liquid crystal layer between the array substrate and the opposite substrate, the liquid crystal layer comprising first liquid crystal molecules;
a lower polarizer arranged on a side of the array substrate away from the opposite substrate;
an upper polarizer arranged on a side of the opposite substrate away from the array substrate;
a lower compensation layer between the lower polarizer and the array substrate; and
an upper compensation layer between the upper polarizer and the opposite substrate,
wherein each of the upper compensation layer and the lower compensation layer comprises second liquid crystal molecules having a birefringence different from that of the first liquid crystal molecules,
wherein a direction of pre-tilt angles of the second liquid crystal molecules in the upper compensation layer and a direction of a light absorption axis of the upper polarizer forms a non-zero first included angle, wherein a direction of pre-tilt angles of the second liquid crystal molecules in the lower compensation layer and a direction of a light absorption axis of the lower polarizer forms a non-zero second included angle.

2. The curved-surface liquid crystal display panel according to claim 1, wherein the first included angle between the direction of pre-tilt angles of the second liquid crystal molecules in the upper compensation layer and the direction of the light absorption axis of the upper polarizer is about 90 degree, wherein the second included angle between the direction of pre-tilt angles of the second liquid crystal molecules in the lower compensation layer and the direction of the light absorption axis of the lower polarizer is about 90 degree.

3. The curved-surface liquid crystal display panel according to claim 1, wherein the direction of the light absorption axis of the upper polarizer is substantially perpendicular to the direction of the light absorption axis of the lower polarizer.

4. The curved-surface liquid crystal display panel according to claim 3, wherein the first liquid crystal molecules in the liquid crystal layer are rod-like liquid crystal molecules, which are substantially in spiral arrangement in a thickness direction of the liquid crystal layer, wherein a direction of pre-tilt angles of an uppermost layer of rod-like liquid crystal molecules in the liquid crystal layer is substantially parallel to the direction of the light absorption axis of the upper polarizer, and a direction of pre-tilt angles of a lowermost layer of rod-like liquid crystal molecules in the liquid crystal layer is substantially parallel to the direction of the light absorption axis of the lower polarizer.

5. The curved-surface liquid crystal display panel according to claim 1, wherein the direction of the light absorption axis of the upper polarizer is substantially parallel to the direction of the light absorption axis of the lower polarizer.

6. The curved-surface liquid crystal display panel according to claim 5, wherein the first liquid crystal molecules in the liquid crystal layer are rod-like liquid crystal molecules, wherein a direction of pre-tilt angles of the rod-like liquid crystal molecules is substantially parallel or perpendicular to the direction of the light absorption axis of the upper polarizer.

7. The curved-surface liquid crystal display panel according to claim 1, wherein a phase delay of light passing through each of the upper compensation layer and the lower compensation layer is between 15 nm and 65 nm.

8. The curved-surface liquid crystal display panel according to claim 7, wherein a birefringence of the second liquid crystal molecules is within a range of 0.001-0.008.

9. The curved-surface liquid crystal display panel according to claim 7, wherein a thickness of the second liquid crystal molecules is within a range of 0.586 μm-1.686 μm.

10. The curved-surface liquid crystal display panel according to claim 1, wherein each of the second liquid crystal molecules has a substantially disc shape.

11. A display device, comprising the curved-surface liquid crystal display panel according to claim 1.

12. The display device according to claim 11, wherein the first included angle between the direction of pre-tilt angles of the second liquid crystal molecules in the upper compensation layer and the direction of the light absorption axis of the upper polarizer is about 90 degree, wherein the second included angle between the direction of pre-tilt angles of the second liquid crystal molecules in the lower compensation layer and the direction of the light absorption axis of the lower polarizer is about 90 degree.

13. The display device according to claim 12, wherein the direction of the light absorption axis of the upper polarizer is substantially perpendicular to the direction of the light absorption axis of the lower polarizer.

14. The display device according to claim 13, wherein the first liquid crystal molecules in the liquid crystal layer are rod-like liquid crystal molecules, which are substantially in spiral arrangement in a thickness direction of the liquid crystal layer, wherein a direction of pre-tilt angles of an uppermost layer of rod-like liquid crystal molecules in the liquid crystal layer is substantially parallel to the direction of the light absorption axis of the upper polarizer, and a direction of pre-tilt angles of a lowermost layer of rod-like liquid crystal molecules in the liquid crystal layer is substantially parallel to the direction of the light absorption axis of the lower polarizer.

15. The display device according to claim 11, wherein the direction of the light absorption axis of the upper polarizer is substantially parallel to the direction of the light absorption axis of the lower polarizer.

16. The display device according to claim 15, wherein the first liquid crystal molecules in the liquid crystal layer are rod-like liquid crystal molecules, wherein a direction of pre-tilt angles of the rod-like liquid crystal molecules is substantially parallel or perpendicular to the direction of the light absorption axis of the upper polarizer.

17. The display device according to claim 11, wherein a phase delay of light passing through each of the upper compensation layer and the lower compensation layer is between 15 nm and 65 nm.

18. The display device according to claim 17, wherein a birefringence of the second liquid crystal molecule is within a range of 0.001-0.008.

19. The display device according to claim 17, wherein a thickness of the second liquid crystal molecule is within a range of 0.586 μm-1.686 μm.

20. The display device according to claim 11, wherein each of the second liquid crystal molecules has a substantially disc shape.
